(19) United States
(12) Patent Application Publication
(10) Pub. No.: US 2024/0311596 A1
(43) Pub. Date: Sep. 19, 2024

(54) Multiple Image Sensors with Varied Optical Properties to Detect Fiducial Marker Patterns for Validating Credentials

(71) Applicant: Mark Fiala, Edmonton (CA)

(72) Inventor: Mark Fiala, Edmonton (CA)

(73) Assignee: Millennium Three Technologies Incorporated, Edmonton, AB (CA)

(21) Appl. No.: 18/183,163

(22) Filed: Mar. 14, 2023

(51) Int. Cl. G06K 7/14; G06T 7/13; H04N 23/13; H04N 23/75

(52) U.S. Cl. CPC G06K 7/1417; G06T 7/13; H04N 23/13; H04N 23/75; G06T 2207/10016; G06T 2207/30204

(57) ABSTRACT

An invention is disclosed for a device capable of more efficient and reliable usage of 2D codes shown on printed matter and smartphone screens for the purpose of efficient and reliable validation of an entity's credentials for applications such as automated door locks and checkpoints to verify entrance tickets at a venue considering adverse lighting and motion blur scene conditions, recycling and orbital or lunar space applications. The novelty includes both an improved 2D code and detection algorithm and the use of multiple image sensors with differing optical characteristics. Optionally a time-varying code increases security.

### PRIOR ART

### US Patent Documents

US 20080149812A1 Ward, Heidrich 6/2008 “HDR camera with multiple sensors”
U.S. Pat. No. 9,514,586 B2 Rogers et al. 12/2016 “System and method for controlling locks”
U.S. Pat. No. 7,769,236 B2 Fiala 8/2010 “FIDUCIAL MARKER PATTERNS, THEIR AUTOMATIC DETECTION IN IMAGES, AND APPLICATIONS THEREOF”
U.S. Pat. No. 10,504,231 B2 Fiala 10/2019 “FIDUCIAL MARKER PATTERNS, THEIR AUTOMATIC DETECTION IN IMAGES, AND APPLICATIONS THEREOF”
U.S. Pat. No. 10,929,980 B2 Fiala 2/2021 “FIDUCIAL MARKER PATTERNS, THEIR AUTOMATIC DETECTION IN IMAGES, AND APPLICATIONS THEREOF”
U.S. Pat. No. 11,100,649 B2 Fiala 8/2021 “FIDUCIAL MARKER PATTERNS, THEIR AUTOMATIC DETECTION IN IMAGES, AND APPLICATIONS THEREOF”

### Other Patent Documents

CA 2566260 Fiala 10/2013 “MARKER AND METHOD FOR DETECTING SAID MARKER” CA 2926861 Fiala 5/2026 “FIDUCIAL MARKER PATTERNS, THEIR AUTOMATIC DETECTION IN IMAGES, AND APPLICATIONS THEREOF

### Other Publications

Abdulhakeem, Sunday. (2014). Enhancing User Experience using Mobile QR-Code Application. International Journal of Computer and Information Technology. 03. 1310-1315.
EOPTIS SRL, 2011, “MAIA-Multispectral Imaging Camera” Lapray, Heyrman, Rosse, and Ginhac (2011). Smart camera design for realtime High
Dynamic Range imaging E. Olson, “AprilTag: A robust and flexible visual fiducial system,” 2011 IEEE International
Conference on Robotics and Automation, pp. 3400-3407

### BACKGROUND OF THE INVENTION

Field of the Invention: the present invention relates to the improved detection of credential information presented on two-dimensional coded patterns on printed matter or displayed on mobile device screens. More particularly, the present invention describes the combination of a special type of patterns with matching detecting algorithms and the usage of multiple image sensors with differing optical characteristics to provide more reliable detection, especially in varying lighting and motion conditions. Applications where this invention can be used including expediting lineups of people moving passing checkpoints, automated door locks, retail customer rewards programs, tracking recycling and space applications.

Background: Coded Pattern Failures: coded patterns such as two-dimensional (2D) barcodes are often used to identify items or convey credential information such as possessing a ticket to enter a venue, access customer reward points at vendors such as fast food or coffee businesses, convey medical status and boarding passes for aircraft. The term “scanning” is used herein to convey the action of acquiring the credentials encoded in the coded pattern, typically through capturing light reflected or emitted from the coded pattern with a two-dimensional image sensor and processing the data with a digital computer. Examples of coded patterns are shown in FIG. 1 include the Data Matrix, Maxicode and QR-codes listed in patent U.S. Pat. No. 7,769,236 B2, an academic system inspired by U.S. Pat. No. 7,769,236 B2 in Olson 2011.

The “Quick Response” (QR-code) is a coded pattern which has become ubiquitous at the time of this writing. While possibly intended to identify items and products, QR-codes have been used in many businesses on printed cards and especially mobile phone screens to show proof of purchase or track loyalty points, they are also common in airline boarding passes and even were used heavily during the COVID-19 pandemic to demonstrate medical credentials.

However, the design of QR-code patterns and the image processing algorithms to detect them, and especially the limited dynamic range of image sensors such as those found in mobile phones, cause delays and many times the encapsulated data cannot be scanned successfully. This results in longer lineups and frustration by human users. Security breaches are also a concern since security guards often waive people through checkpoints just by seeing that they have a QR-code on their phone, knowing that the scanning process will be tedious and error prone.

Kiosks and hand-held scanners have been created specially to better detect QR-codes, often with a laser or other additional illumination. This can work faster with printed patterns but can create further imaging problems with reflection and over-saturation of its image sensor if the QR-code is displayed on a mobile device screen. If the QR-code is presented on a mobile device screen instead of printed matter the brightness levels of light and dark elements of the pattern are not as predictable and reach more extreme values causing scanning failure. QR-code scanning devices intended for printed patterns used naively to scan those displayed on mobile devices is a common source of failure.

So called “Smart Cameras” are self-contained units often designed to scan patterns like QR-codes. However, they often fail in outdoor situations, especially if the QR-code is on a mobile device screen. They work best in controlled lighting environments such as packages travelling on a conveyor belt or airport luggage handling system where the scanning location is enclosed and with artificial consistent lighting.

Attempts exist to utilize QR-codes at drive-through businesses to identify customers with patterns presented on their mobile device, but even with specially built hardware for detection this often fails in bright sunlight or at night.

QR-codes displayed on mobile devices have been used to unlock automated door locks such as described in patent U.S. Pat. No. 9,514,586 B2. However, this is typically only done indoors such as in hotel hallways where the lighting is consistent.

The failure to extend QR-codes, or similar coded patterns, from controlled factory lighting environments as per their original invention, into common use displayed on mobile phones in varied lighting situations found in common situations is due to their failure to work reliably. The reliability failure is due to inherent design of QR-codes based on the steps of thresholding and “blob detection”. Reference locator features consisting of concentric alternating light and dark shading must be found first and are vulnerable to lighting and similar shades touching the pattern. Finding a threshold value to distinguish the light from the dark within the locators is problematic with the uncontrolled lighting that is present in real world applications (see FIG. 2).

Additionally, security problems are created by using QR-codes, or any 2D coded pattern, on a mobile device screen since they can simply be “screen captured” where the contents of the device screen are saved to an image file and sent to collaborators who simply present it on their phone mimicking the credentials of the original valid coded pattern.

Varying lighting: the visible light illumination of a scene can vary greatly from up to 133,358 lux in an orbital space application to 50,000 lux in bright daylight conditions on Earth to 150 lux or lower in a moderately dimly lit warehouse or movie theatre entrance (1 lux=0.0079 Watts/Square Meter). The Irradiance is incoming light intensity that arrives at an image sensor measured in the same units. For printed fiducial marker patterns the irradiance is the reflected light will be a reduced value of the light illumination of a scene. If the fiducial marker pattern(s) is/are shown on a mobile device the brightness can exceed that of the reflection of a printed pattern. Image sensors (cameras) have a lens, possible iris diaphragm and a light sensitive image sensor planar device (usually created in an integrated circuit process). An image sensor typically converts irradiance into digitally measured values between a minimum and maximum value corresponding to some minimum and maximum irradiance levels. The difference between minimum and maximum irradiance levels is known as the dynamic range and is often characterized as the logarithm of the maximum value divided by the minimum value. This dynamic range for electronic devices is typically less than that of the human eye, and usually has a fixed, manually mechanically adjustable, or automatic motorized iris diaphragm as well as an electronically controlled biasing signal and electronic shutter to adjust the level of incoming light. However, adjusting the level of incoming light modifies both the minimum and maximum irradiance levels as per the device's dynamic range. The irradiance difference between the darker and lighter parts of a fiducial marker pattern may not be within the image sensor's range and thus it is often the case that a single image sensor cannot detect the pattern(s) without adjustment as shown in FIG. 2. Furthermore, within a scene one fiducial marker pattern may be in an area of brighter illumination compared to a second pattern in an area receiving less illumination causing it to be impossible to simultaneously detect both as that all four irradiance levels (light and dark values from one pattern, plus light and dark from the second) cannot all be within the instantaneous range of the image sensor. It is often difficult to set this iris to a given illumination situation, especially if it is outdoors where lighting changes constantly or the pattern(s) is/are displayed on a mobile device screen which may not be suited to the lighting environment. I.e. in sunlight or dark environments the patterns are likely to not be detected. A common occurrence is that due to the automatic electronic iris function of a scanning device, the device adjusts to the scene such as bright sunlight or a dark night scene which is not suitable to detect the pattern which is suddenly presented, especially from a mobile device screen whose emitted light is not the same as the reflection from a printed marker, the reflection being more likely to fit within scene lighting. This is the common experience found, especially by those in situations such as staff attempting to validate customer rewards cards at vehicle drive-through businesses, staff attempting to validate user tickets entering a venue with bright mobile phone screens, or staff attempting to validate medical information at venues in the evening on paper documents.

Background: motion blur: for many use cases where the pattern(s) and the image sensors are moving with respect to one another, such as a stationary checkpoint camera and a moving person holding or wearing a pattern, the detection ability can be degraded as the moving object is spread (“blurred”) across the image. Image sensors typically contain an electronic shutter which enables and stops the collection of light for each pixel within the captured image. This is a result of a combination of factors in the formation of a projection image in the image sensor from what is in the scene. Depending on the light gathering ability of the image sensor, determined by the image sensor technology, the size of the actual light sensitive area of the imaging device and the amount of irradiance (incoming light). If the scene lighting is too low for the light gathering ability then the electronic shutter is forced to be open longer, during which time the object or scene can move resulting in a blurred image projection of the scene objects. The practical result is that with most image sensors available at an affordable price currently used in computer webcams or mobile device cameras as the time of this writing cannot detect a fiducial marker pattern of convenient size held or worn by a person when they are moving in an indoor scene such as a warehouse with typical illumination of 150-250 lux, and the person is forced to stop for a period of time to allow detection, clearly deteriorating the usefulness of the system which should work passively without user attention.

Background: camera-mounted lighting: portable scanner systems are employed in logistics to read the credentials of an object from the affixed linear barcodes or QR-code patterns. These scanner systems typically have their own light source or laser aimed in the forward direction when held by a person. Thus they carry their own lighting to avoid all the above mentioned lighting problems because the scanner's light overwhelms scene lighting to produce a predictable irradiance range. Additionally a person holding the scanner naturally holds it stead with respect to the affixed pattern avoiding motion blur. In this application there is a human user purposefully aiming the scanning system at a pattern and so an embodied light source is not inconvenient. It should be noted that even with this embodied lighting these scanning systems still have trouble validating patterns shown on mobile phone displays since the emitted light is not within the designed expected reflectance range. However, in applications such as checkpoint verification placed in fixed positions with people or machines passing by it is often not appropriate to have extra lighting, which may not be effective anyways if patterns are shown on mobile device screens. Therefore the existing scene variable lighting and unknown brightness of mobile device display screens must be adapted to, forming the motivation for this invention.

Background: use in retail businesses: businesses aimed at public customers often use “reward cards” or apps that contain a QR-code that benefit the customer with bonuses and enable the business to track the customers' purchases and bring up orders faster. This has been in the form of printed cards with patterns of linear barcodes or QR-codes, or in mobile device apps with a QR-code displayed. These have also been attempted at drive-through businesses but the scanning operation, where the customer credentials are read out, is a typical point of failure. This failure is exasperated by outdoor uncontrolled lighting conditions and the bright screen of the mobile device displaying the pattern. Additionally businesses are attempting to build application specific “Smart Camera” units with a dedicated image sensor and often a fixed light shield for the user to hold their mobile device against to block the unknown environment lighting. However, environment lighting often leaks through and the brightness of the mobile device screen is out of the system's control. Smart cameras have also appeared in attempts to track recycled products.

Background: edge based fiducial marker patterns: superior results can be achieved with patterns designed differently from QR-codes that don't use the reference locator features' projection in the image to detect the patterns but instead join together edges into polygons that can contain the pattern(s)′ projection in the image. This removes the need for threshold digitized pixel irradiance values to decode the pattern (Threshold A and Threshold B in FIG. 2). Patent U.S. Pat. No. 7,769,236 B2 teaches this method and patents U.S. Pat. No. 10,504,231 B2, U.S. Pat. No. 10,929,980 B2 and U.S. Pat. No. 11,100,649 B2 details applications and algorithm improvements but don't specify a system where multiple image sensors are aimed at the same scene with differing optical characteristics to provide reliable detection under varied lighting.

Background: time varying codes: a commonly used security mechanism is to utilize a time-varying synchronized sequence of numerical codes. Apps or mobile devices or dedicated separate hardware devices (e.g. in keychain form) present a sequence of characters or numbers as credentials to enter into keypad or webpage to validate the user's identity. These alphanumeric, or simply numerical, sequences change with time that is synchronized between the user's app or device and the system requiring verification. This is often not sufficient to fully identify the user but adds a level of security over just a password. A drawback of this is that it is time consuming to access this app and device to fetch the latest sequence, slowing down entry into services.

Background: multi-sensor cameras: electronic devices having more than one image sensor exist such as mobile phones with multiple image sensors with different focal lengths. However the intention is to provide the user with different field of view options and only one of these is providing used data at a time. Furthermore, this multi-sensor array is not designed to detect fiducial marker patterns in extreme lighting by careful selection of intensity filters. Patent U.S. Pat. No. 10,929,980 details an array of image sensors mounted on a rigid frame arranged facing outwards for the purpose of calculating the position and orientation of the frame, such as a wearable augmented reality helmet. This differs from the present invention in that the image sensors are not viewing the same scene, and likely have the same optical properties, and the system was not designed to combat lighting variation for credentials verification. Similarly there are many security cameras with multiple sensors aimed in different directions. Multi-sensor cameras with sensors all viewing the same scene exist for multi-spectral imaging intended for crop surveillance such as the EOPTIS 2011 Multispectral Imaging Camera with nine separate image sensors with different filters. However, their filters filter light by wavelength to detect plant growth properties and aren't intended to handle different levels or lighting or to detect fiducial markers.

Background: HDR (High Dynamic Range) cameras exist that compensate for the limited dynamic range of one integrated circuit image sensor by. Lapray et al. (2011) use a single image sensor with consecutive images taken with different exposure times to combine into a single image with a larger light to dark range. However, it is only to achieve superior photographs and not intended for automatically detecting fiducial marker patterns to validate credentials. And capturing images at different instants in time is not suitable for moving objects such as moving people holding credentials. US 20080149812 teaches a multi-sensor camera for HDR imaging but an aperture controls one of several image sensors to view light through the same lens in or to keep the identical viewpoint, the image sensors are not run concurrently but consecutively as in the previous example and are not intended for the automatic credentials validation. Also these systems aren't useful in examples such as orbital space operations with objects in motion where it is not desirable to wait several image frame times for the exposure that might detect a pattern.

### SUMMARY OF THE INVENTION

The present invention requires both the improved edge-based 2D fiducial marker patterns and the use of multiple image sensors with differing optical characteristics so that the device can detect said patterns in varied environments such as dim indoor and bright outdoor lighting.

The edge-based patterns provide superior performance compared to the popular QR-codes (Quick Response) in the aspects of longer detection distance, greater immunity to lighting variability and partial damage to the pattern and the ability to simultaneously detect many at once. By itself this algorithm provides superior detection performance even with one image sensor but is still limited by the dynamic range of the single sensor, thus the unique addition of multiple simultaneously operating image sensors is a key to the present invention.

With each image sensor providing an image captured with different optical parameters, such as response to irradiance level (incoming light intensity) or polarization, a set of multiple images are simultaneously provided of the scene to be processed to detect the pattern(s), where the chance that one of them will detect the pattern(s) is higher than if the system had only one image sensor.

If the image sensors differ in irradiance sensitivity properties due to design settings (lens size, physical iris diaphragm and its setting, electronic biasing, shutter exposure time setting, mounted filter and light sensitivity of the integrated circuit light sensor array itself) then the irradiance levels can be chosen by considering both the dynamic range of the integrated circuit and the expected light vs dark irradiance for patterns. The expected irradiance levels are that seen under different illumination if printed or screen intensity if shown on a mobile device screen. Thus the light sensitivity range for each image sensor can be chosen such that within the combined set of all the image sensors one of the image sensors will have a range of minimum to maximum irradiance that encompasses the light and dark irradiance values for any reasonably expected lighting situation. I.e. each image sensor's irradiance range is carefully chosen. This is shown in FIG. 2.

Additionally motion blur can be accommodated for by the correct choice of light gathering image sensors for different irradiance and illumination ranges.

Important for practical implementations of the present invention, combined device can maximize size and cost efficiency by utilizing lower cost and smaller image sensors for the ones with the highest irradiance level and use the more expensive larger image sensors only for the lower (darker) irradiance levels. In general a smart camera will likely have a range of different sized lenses visible on the outside with the smallest lens capturing the least light for the highest (brightest) irradiance range. Additionally if there is a motion requirement, as in lineups of people passing a checkpoint, the light sensitive integrated circuits can be sized appropriately and not exceed necessary sizes since the cost typically rises exponentially with the physical size of the light sensitive area (for example, an integrated circuit to capture enough light to detect a 5 cm pattern moving at 10 M/s in a dim warehouse illuminated at 150 lux costs perhaps 250 times the cost of an integrated circuit from a mobile phone that can perform this in bright sunlight).

The present invention is anticipated to be embodied in a smart camera single box with the above design criteria to perform reliably in widely ranging indoor and outdoor unpredictable lighting. The present invention allows proper use of 2D barcode like credentials on printed matter and mobile device display screens for such use cases as people streaming past a checkpoint to enter an entertainment venue, for drive-through businesses, for recycling applications, and for specialized cases such as space operations, high altitude visibility weather stations and even insect tracking.

### BRIEF DESCRIPTION OF DRAWINGS

FIG. 1 shows several coded marker patterns in common use.

FIG. 2 demonstrates the irradiance problem encountered with fiducial marker pattern detection. An image frame from an image sensor is shown. Below is a histogram of pixels in a digital image where these irradiance values have been digitized for each pixel, only the irradiance values found within the borders of the pattern are shown, excluding the rest of the scene pixels. The horizontal scale of the histogram is in logarithmic units since irradiance can vary from 150 to 100,000 lux (W/square-M). With conventional marker detection such as QR-code detection, the image processing algorithm must select a single threshold irradiance value to separate the light (typically logic ‘1’) pixels from the dark (typically logic ‘0’) pixels, Threshold A shows how a threshold can be chosen to partially separate light from dark pixels in the pattern in the darker illumination. Note that it is impossible to select a single threshold that completely separates light from dark pixels, such as if lighting changes across a pattern, one reason the edge-based detection algorithm described in the present invention provides more reliable detection. Note also how with a single threshold as typically done, one cannot simultaneously detect the pattern in the brighter side of the image and the pattern in the dark side as that they would require different thresholds Threshold A and Threshold B respectively, this is avoided with the edge-based detection algorithm (which does not use a threshold) but only if both patterns can fit into the dynamic range of one image sensor. This edge-based detection cannot detect both if the two patterns irradiance levels are further apart than the dynamic range. Finally, at the bottom of the figure, the selection of irradiance ranges for a multi-sensor system if show, note how each image sensor is provisioned to respond to a different range of light irradiance levels, either by different settings in a variable iris diaphragm, different electronic shutter exposure time, different intensity filters applied, a different integrated circuit light sensor array, or a combination of the above. Note the staggered and overlapping dynamic ranges allowing for detection of patterns that would cross the edges of neighboring image sensors if their ranges did not overlap. As described for a practical product, Sensor #1 would likely be the most expensive image sensor with the physically largest with the largest lens and integrated circuit with the largest light sensitive area, and Sensor #4 could be a very low cost device with a micro-lens such as those produced for lower priced mobile phones.

FIG. 3 shows several fiducial marker patterns, both “single markers” and “composite markers”. The former pattern consists of a single polygonal (square in these examples) shape with data cells in the interior, whereas the latter is composed of a number of single markers in a fixed and deterministic relationship to each other. The term “marker” refers to the term “patterns” described in this invention.

FIG. 4 shows the structure of the common coded pattern known as QR-codes, sometimes referred technically as QRC's or “3-dimensional codes”. The “finder pattern” shows the three concentric “blobs” that must be detected first to locate the pattern, a fragile part of the scheme that relies on successful determination of white and black levels to be input to a connectivity algorithm to find the three concentric closed “blob” shapes. Also, the coded interior can only be determined up to a non-perspectively warped affine transformation. QR codes were first created in 1994 by Denso Wave Incorporated, Japan. This image is from Abdulhakeem, Wara & Dugga, Sunday. (2014). Enhancing User Experience using Mobile QR-Code Application. International Journal of Computer and Information Technology. 03. 1310-1315.

FIG. 5 is a graphic depicting the average measured distance gain that the detection method in claim 1 can achieve over QR-codes, motivating the algorithm.

FIG. 6 is a graphic depicting a “Smart Camera” embodiment of the present invention where three image sensors are mounted into a case with all sensors viewing the same scene. An output means of a wireless antenna to convey the acceptance or rejection and/or information about pattern(s) is shown.

FIG. 7 is a front view of an implementation smart camera with 4 different combinations of image sensor, lens and optical filter. The larger sensors are responsible for the lower (darker) irradiance levels and the smaller sensors below are for the higher (brighter) irradiance levels. The processing of the imagery is performed inside the device. This implementation also has 2 different output means for outputting the acceptance or rejection and/or information about pattern(s) it detects.

FIG. 8 shows a human user presenting their credentials in the form of either a printed fiducial marker pattern or their mobile device with it displayed on the screen. The view from one of the image sensors in the smart camera is depicted on the right. This view can also be shown on a screen with acceptance or rejections and/or other information shown drawn over this view, such as drawn near the pattern.

FIG. 9 shows the view displayed on either the smart camera, or more likely a large screen visible near a checkpoint or door. The user sees one of the smart camera image sensor's views with an acceptance or rejection graphic overlaid in a way that is intuitively clear as to which pattern's credentials it refers to in the case such as FIG. 10 where there is more than one user seeking validation at the same time. Left to right: a blank view for comparison, a checkmark icon typically shown in green for clear viewing, and a failure ‘X’ icon typically shown in red for clear viewing. Typically an audio sound would acknowledge the acceptance or rejection.

FIG. 10 shows a lineup of people holding credentials in the form of a printed fiducial marker pattern or their mobile device with it displayed on the screen. The output means includes the large display screen where everyone, including the security guard, can easily see the acceptance or rejection for each individual. Since the smart camera can show several people at once and their acceptance/rejection decision it is possible for people to stream past the checkpoint at an efficient speed.

FIG. 11 shows a smart camera mounted on a gateway validating a person entering a facility, in this case a sailor boarding a naval vessel. In this figure the fiducial marker pattern is presented on their mobile phone. Furthermore, the pattern is time-varying in a sequence known to the smart camera as an additional security measure. The output means is not shown but a display, light or sound could be part of the gateway.

FIG. 12 shows the same situation as FIG. 11, except that the fiducial marker pattern is affixed to the sailor's uniform so that they can just walk past.

FIG. 13 shows a smart camera mounted into a kiosk at an airport, the person is holding their mobile phone so that the kiosk's smart camera can see the fiducial marker pattern on the mobile phone's screen. The pattern can be static or time-varying as in FIG. 11.

FIG. 14 shows a smart camera mounted controlling the electronic lock for a door. The human user is holding either a printed fiducial marker pattern or their mobile device with it displayed on the screen.

FIG. 15 shows a recycling application. A smart camera, or at least its image sensors, is mounted on a disposal bin detecting pattern(s) printed on items to be disposed. The credentials being verified are whether that item has been returned or not. Additional information of what account to credit some points or money for returning the item is likely encoded on another pattern belonging to the person claiming the recycling credits. In this example a coffee cup with a pattern consisting of a triple linear marker depicted is detected by the smart camera mounted next to the inlet of the recycling disposal bin. The user's recycling account identity is also detected. Typically the recycling identity is established during or before or after the recycling items themselves are deposited by the user showing a pattern on their mobile device or showing a printed card they retain.

FIG. 16 shows a drive-through business application, such as a fast food or coffee provider, where a pattern is mounted in some convenient place, such as slid behind the windshield, for recognition by a smart camera mounted at the drive-through. The pattern's credentials contain some customer information which can be used with the integration of a database to see their regular orders to more efficiently predict their order, to apply loyalty points, and other business related data.

FIG. 17 shows a system diagram where the application is a checkpoint where the purpose is either to merely notify the user and possible security guard(s), or to transmit the presence of the user to some external system, or both. This figure shows the case where the validation decision is made within the device.

FIG. 18 shows a system diagram where the application is an electronic door lock. Either the static (unchanging) or time-varying fiducial marker pattern(s) is/are seen by one more of the multiple image sensors and outputs control signals to the electronic lock, unlocking or locking it according to the acceptance or rejection criteria. The display screen and audible sound generators, typically a speaker or buzzer, optionally aid the user in operating the device. This figure shows the case where the validation decision is made within the device.

FIG. 19 shows a system diagram where the validation of credentials is performed on a remote server computer communicated to via a computer network. The detection algorithm provides a list of detected patterns which are sent to the server which replies with acceptance or rejection and/or information about the pattern(s). This is useful in applications where there is only one set of validation rules; for example, in an entertainment venue whether to accept a ticket needs to be checked with a central database to prevent that pattern from being used more than once fraudulently at multiple times or locations.

FIG. 20 shows a system diagram similar to FIG. 19 where the validation is performed locally in the device, but requires information from said remote server. This is useful when the validation rules can vary between locations, for example when checking work experience safety credentials at different worksites.

FIG. 21 demonstrates a time-varying fiducial marker pattern displayed on a mobile phone. In this example after a few seconds the pattern changes, but the smart camera will decode the same credentials.

FIG. 22 shows three different image sensors, the leftmost two are shown without lenses. All three have different light capture properties including wavelength range.

FIG. 23 outlines the process of detecting fiducial marker patterns described in claim 1. An edge detector is first used to detect an edge in an image frame (from a still image or a single frame from a video sequence), these are combined into a set of possible line segments, some of which can be grouped into hypothetical polygons including adapting to different types of broken or missing borders as in FIG. 24. Each polygon is tested to see if it is a border of a valid fiducial marker pattern by calculating a mathematical homography matrix which allows sampling of data cells within the pattern to form a set of digital data. This data is then tested in all possible orientations for that polygon, eg. 4 for a quadrilateral polygon, 5 for a pentagon, etc. The data extracted from each orientation is processed using data integrity techniques including error correction and checksums to fix possible errors in the data and to test if it is indeed a valid set of data. If so, the acceptance criteria are applied to either determine the identity and/or determine if the credentials associated with this fiducial marker pattern satisfy the acceptance criteria.

FIG. 24 shows how the hypothetical polygons described in FIG. 23 can be inferred even with broken or missing polygon borders.

FIG. 25 shows the use of fiducial marker pattern(s) is tracking the movement in insects in scientific studies. The credentials encoded in, or linked to, the pattern is the individual insect identity. Lighting variation problems and the cost and complexity of such a system can be reduced with the utilization of this invention.

FIG. 26 demonstrates the use of the invention in the depicted automatic visibility detection in weather stations. Outdoor situations have great light variations addressed by the multiple cameras in this invention and the disclosed detection algorithm provides more reliable detection at distances.

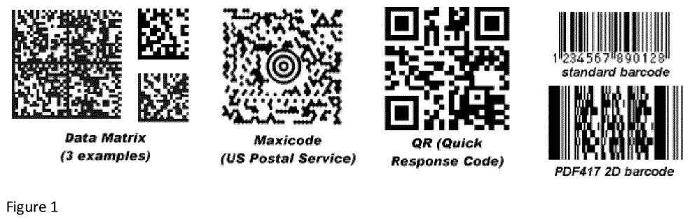

### DETAILED DESCRIPTION OF THE INVENTION

An invention is disclosed for a device capable of more efficient and reliable usage of 2D codes shown on printed matter and smartphone screens for the purpose of validating credentials. The invention is composed of two key elements: a superior edge-based fiducial marker pattern detection technology as compared to QR-codes, and the use of multiple image sensors viewing the same scene each with differing optical characteristics such that in varied environments such as dim indoor and bright outdoor lighting at least one of the image sensors is likely to produce an image in which the pattern(s) are detected to be able to validate the credentials. The captured image from each image sensor is processed with this edge-based detection technology to detect these patterns. Optionally a time-varying code increases security.

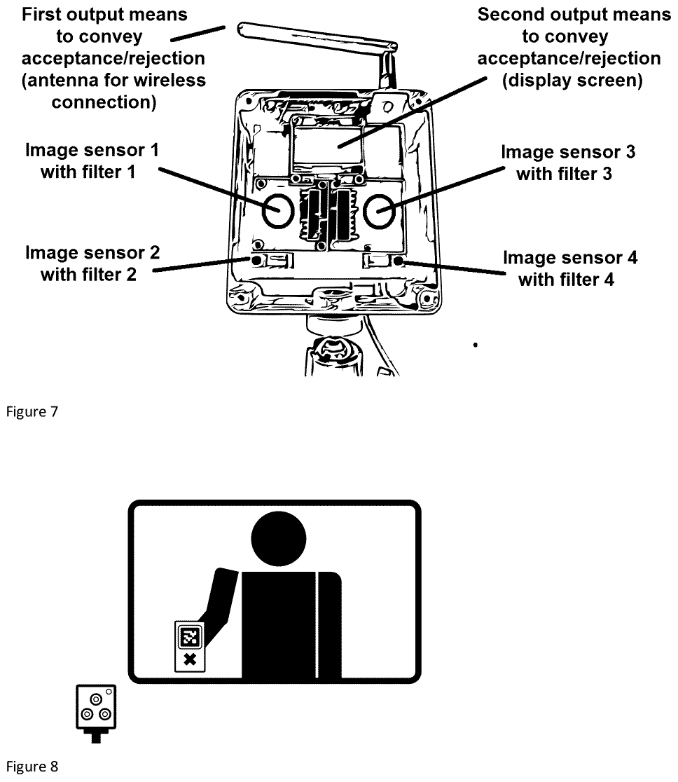

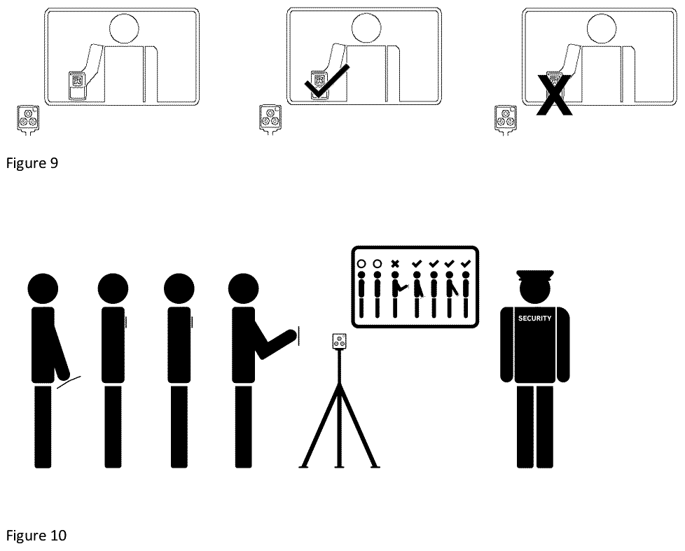

In one embodiment of the invention the image sensors, processing electronics, output means to report results and optionally a battery power supply are all enclosed within a single case forming a self-sufficient device, a so-called “Smart Camera” shown in FIG. 6 and FIG. 7.

In another embodiment the image sensors are separately mounted in the scene of interest, but their video outputs are sent over cables or networks to a remote computer to perform the same pattern detection tasks. Examples include the use of already built environment hardened security cameras such as those using the Power Over Ethernet (POE) standard.

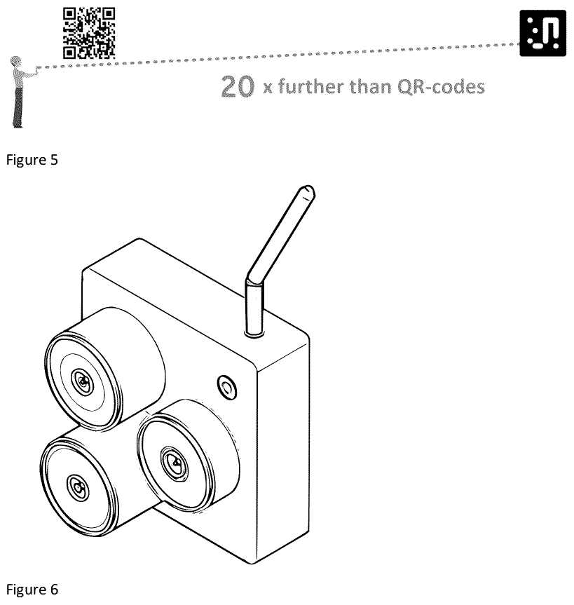

The combination of both the improved patterns with their edge-based detection algorithms and the use of multiple image sensors with different optical properties improves the ability to work at large distances, and under motion, in commonly encountered varying lighting. The improved 2D pattern internal design and the image processing algorithms to detect them provide superior detection to QR-codes, typically allowing detection of distances up to 20 times or further with the same pattern physical size and image sensors, as depicted in FIG. 5.

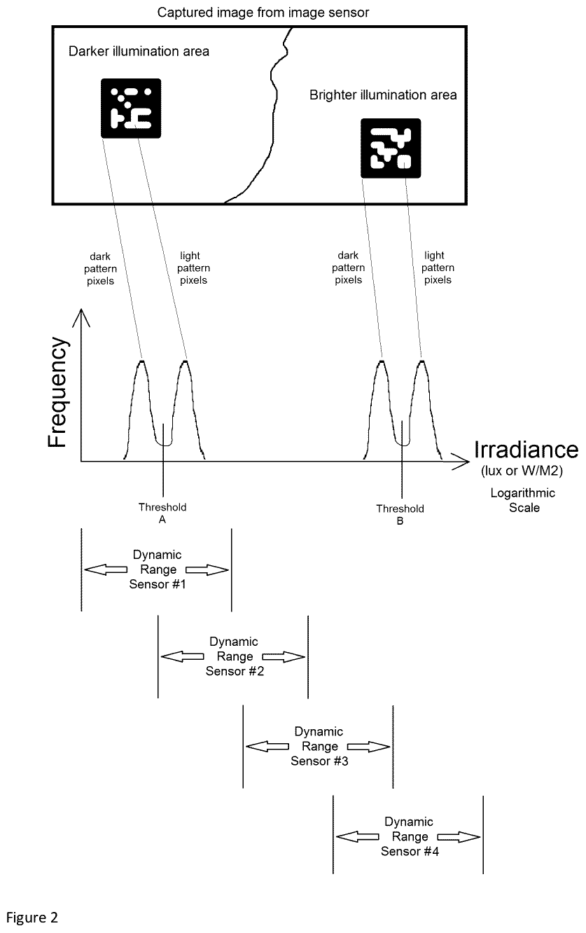

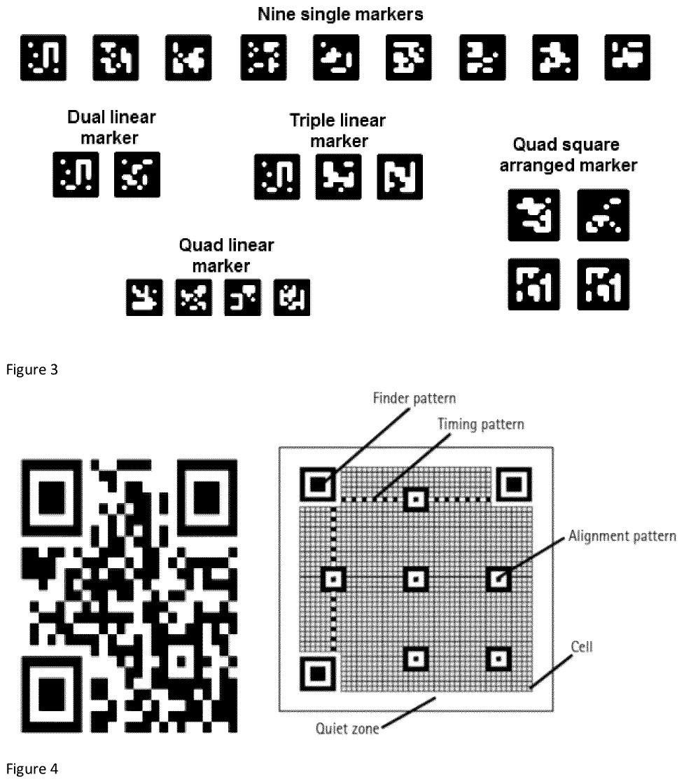

In one embodiment of this invention all the image sensors are specified to respond to the same range of visible light wavelengths, have the same physical size of the light sensitive area and the same resolution (number of discrete pixels) and lenses, but each sensor has a different effective (differing iris diaphragms or similar set to a different position in the range, the “F-stop”). Thus each image sensor is responding to a different range of light intensity. In another embodiment some image sensors are fitted with polarization filters set to different polarization angles, for use where reflections are likely polarized and not what the device wishes to detect. Since iris diaphragms are often built into lens assemblies, another embodiment involves different lens and effective iris combinations. In another embodiment different image sensors of different physical light sensitive area size are used allowing the sensors responsible for the brighter illumination intensity range to be of lower cost and smaller construction; the cost of image sensors typically increases dramatically with the area of their light sensitive area. This latter embodiment is the preferred expected design most likely practically to be built. FIG. 2 shows how the provisioning of different light sensitivities and therefore different dynamic ranges allow for the simultaneous detection of patterns of bright and dark irradiance in the same scene, for example in an orbital space application where some printed patterns are reflecting full sunlight whilst others are in the shade, and it is desirable to detect both at once.

In another embodiment the image sensors differ in the use of polarization filters, useful for special cases where the patterns' incident light comes from sources or passes through media or reflects in a way that considering polarization improves detection at given polarization settings.

In yet another embodiment non-visible light or a mixture of visible and non-visible light can be used. One or more of the image sensors within the device can be receptive to the infrared (IR) range of light and possibly be accompanied by an IR illumination source.

The entity containing the fiducial marker pattern(s) can be a person, but can also be a vehicle for use in applications such as the entrance to an automated parking garage or for use with a drive-through business to identify the customer and predict their order as depicted in FIG. 16.

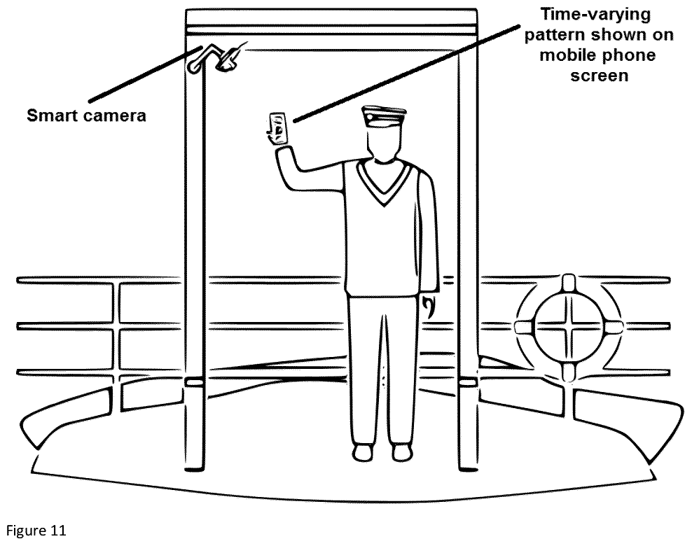

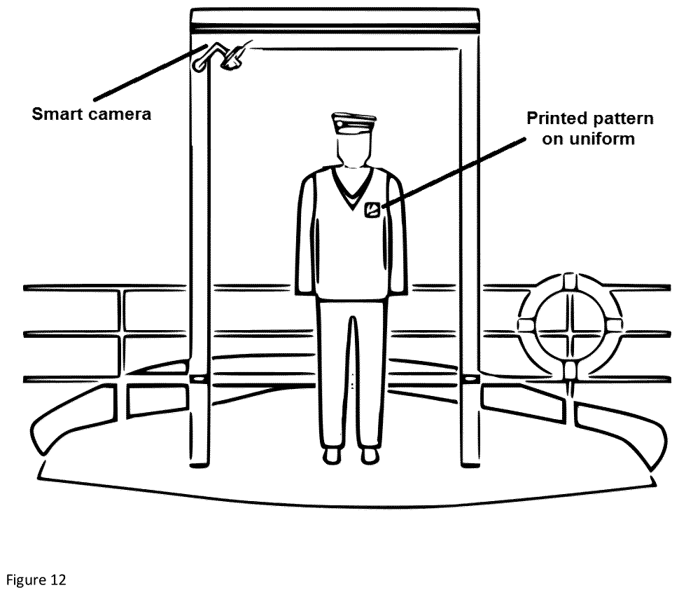

For applications where the entity containing the fiducial marker pattern(s) is a person the credentials can be their identity as valid crew to enter a vessel or workers eligible to enter a worksite as shown in FIG. 11 and FIG. 12.

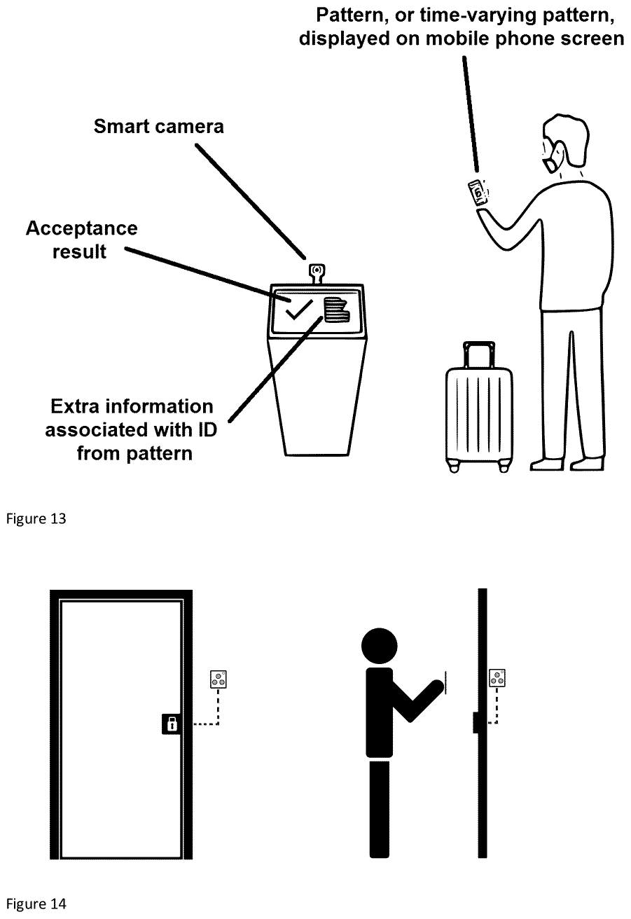

For applications where the entity containing the fiducial marker pattern(s) is a person the credentials can be boarding passes, proof of prior security validation or medical vaccination proof as depicted in FIG. 13.

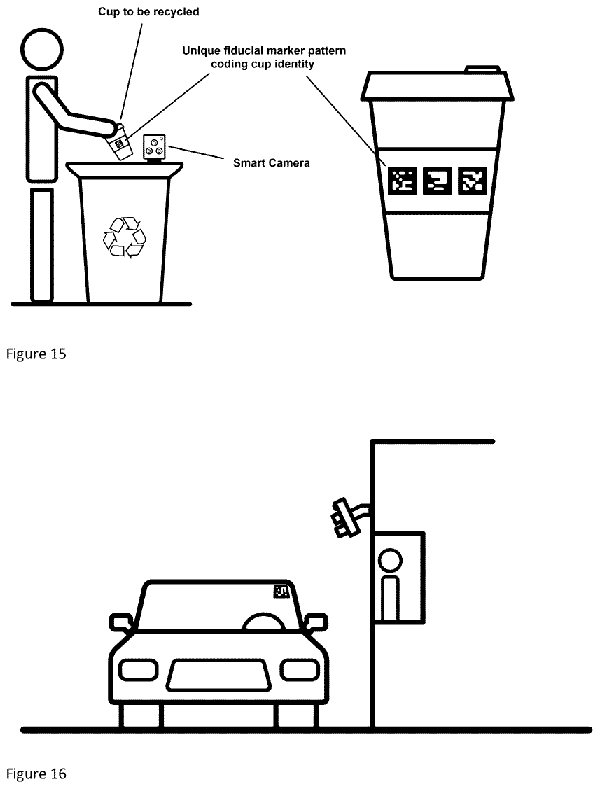

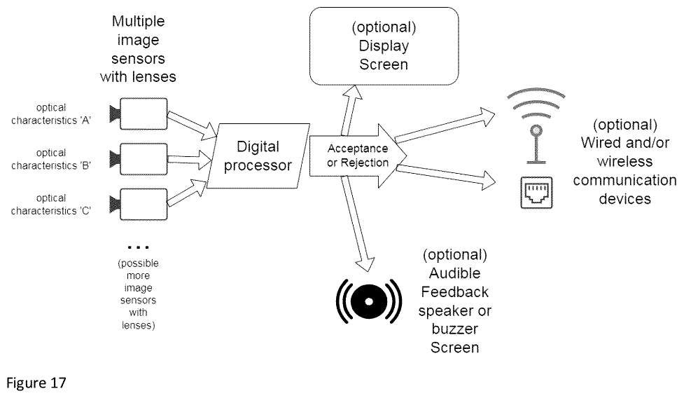

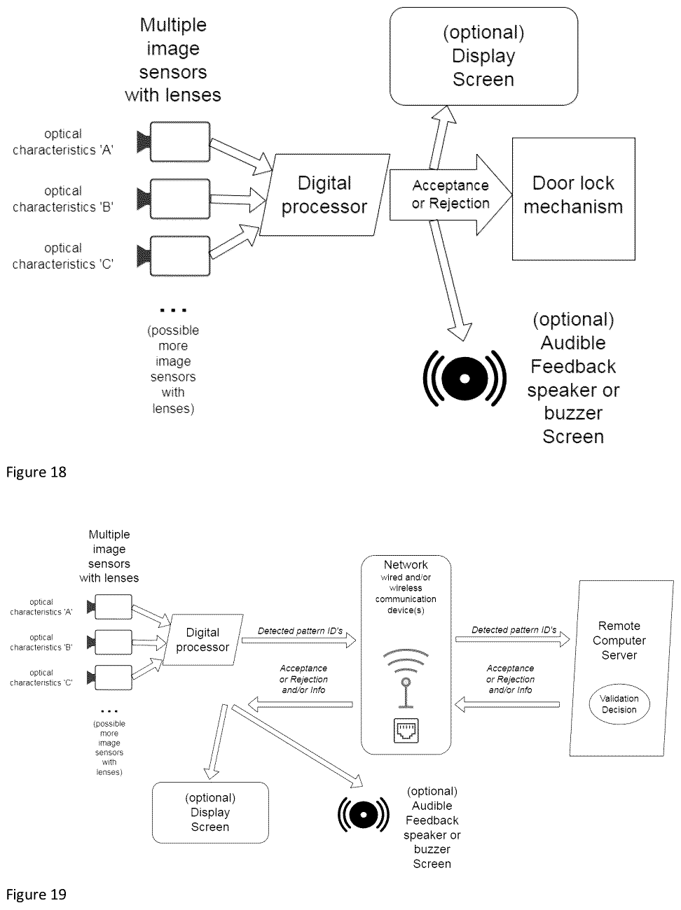

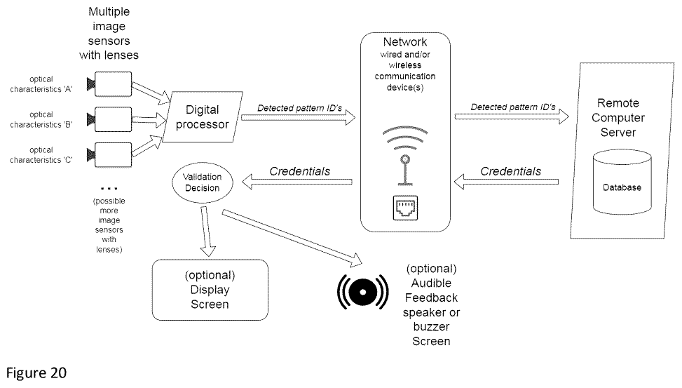

The entity containing the fiducial marker pattern(s) can also be items intended for recycling, with an additional identity being a recycling account with credentials in a pattern on a user's printed card or mobile device that is likely detected with the same smart camera embodiment, as shown in FIG. 15.

The entity containing the fiducial marker pattern(s) can also be a robot entering an area of a facility.

The entity containing the fiducial marker pattern(s) can also be objects such as animals being tracked, FIG. 25 shows the use of fiducial marker pattern(s) is tracking the movement in insects in scientific studies. In this application a fleet of computers were used to process the video and detect the patterns in software. However, it would have been more efficient and performant if the pattern detection could be achieved inside the camera device, and especially if the camera has multiple image sensors to handle different lighting and wavelengths.

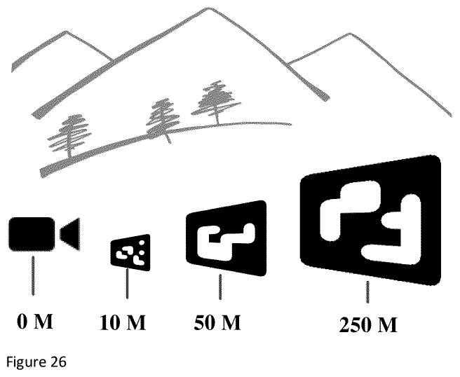

In another embodiment of the invention the fiducial marker pattern(s) are mounted stationary always in view of the image sensors at different distances as shown in FIG. 26 for the purpose of automatically calculating distance of visibility, a meteorological measurement. Such measurements are typically performed in remote outdoor conditions such as mountain tops where the extreme lighting variability requires the use of the multiple image sensors with different optical properties.

Regarding validation of credentials there must be some algorithm or database that converts the patterns' digital codes extracted by the edge-based algorithm from all the image sensors into either an acceptance or rejection decisions and/or produce information to display. The detection algorithm provides a list of detected patterns in each image sensor. In one embodiment the validation is implicit in the patterns' codes, for example the patterns' codes are integer numbers and those fitting within a range are considered accepted. In another embodiment the patterns' codes are searched within a database inside the device to determine acceptance or to generate the information to display and report. In yet another embodiment the patterns' codes are sent over a network to a remote server computer which contains this database which performs the validation decision and/or accesses information not present in the patterns' codes and returns this decision and/or information, simply returns information and the device has to perform the validation decision, or a combination of both. For example, in an entertainment venue whether to accept a ticket needs to be checked with a central database to prevent that pattern from being used more than once fraudulently at multiple times or locations. In a similar application, smart cameras built into recycling disposal bins could allow a user to claim credits as an incentive for depositing items intended for recycling such as disposable coffee cups and lids, each cup and/or lid would have its own unique pattern printed on it corresponding to credentials for that item where the validation process determines in a central database if that item has been returned yet (FIG. 15 and FIG. 16).

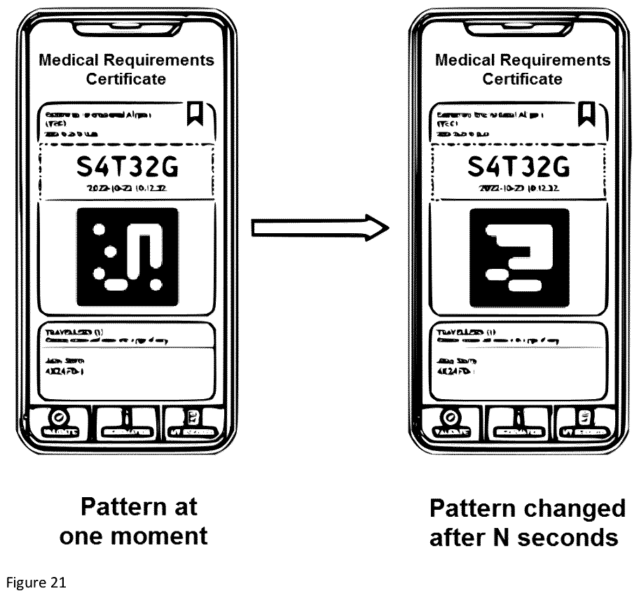

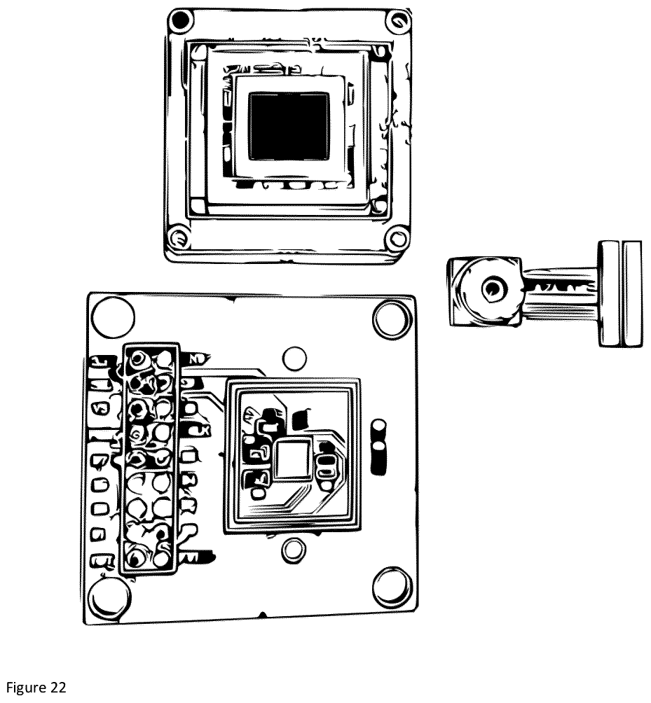

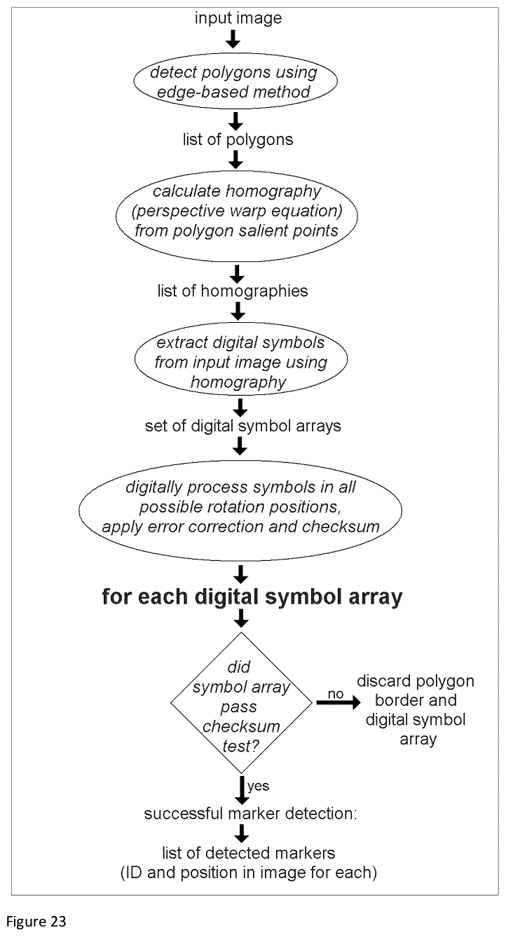

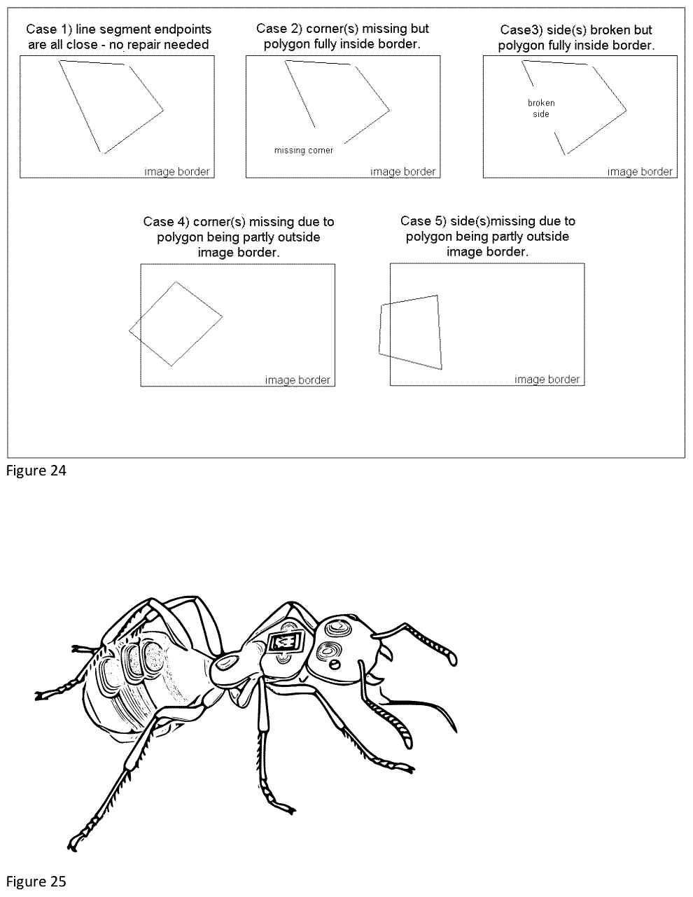

Time-varying codes are an important element for applications involving security such as electronic door locks. In an embodiment of this invention the system or device contains a time reference which is synchronized with that of a mobile device of the entity seeking validation. The mobile device generates a pattern to display on its screen for a given period of time which is only valid for this period of time, after which this pattern changes. The validation takes into account both the detected pattern(s) and the current time to determine the acceptance or rejection of the pattern(s) and optionally the identification and extra information to display. In a further refinement there is an identification unique number assigned to an individual that is converted into the pattern(s) to display using the current time using a secret algorithm possibly including a secret conversion table; the validation means contains the inverse algorithm and a possible matching secret table to combine with the current time to perform the validation decision. An example of this is an employee gaining access through a locked door into a secure location by showing their mobile phone's screen which has the security app running; where this app has already been loaded with a unique identification number; where the pattern(s) on the screen are detected by one or more of the image sensors mounted on or near the door which is able to validate the individual and unlock the door, and optionally record and transmit the unique identification number and the time and possibly a stored image of the individual at the moment of validation for possible future forensic examination. FIG. 21 shows a mobile device screen at two instances of time when a different pattern is displayed, this for a similar medical application such as confirming vaccination status. As with the security devices described in the background, such as keychains or mobile apps where 6-digit numbers change every 30 seconds, the validation means would likely allow codes from the prior and the next time window as well as the current one, to allow for slight variation between clocks inside the mobile app generating the pattern and the smart camera or computer containing the validation means.

In suitable applications it would be useful for human users or nearby security guards to see the result of the acceptance or rejection criteria, and so the results can be displayed on a screen showing images or video from one of the image sensors with overlaid graphical icons displaying the result as shown in FIG. 9 and FIG. 10

1. A requirements verification system comprised of: one or more two-dimensional fiducial marker patterns visible on the entity whose credentials are being verified; where said pattern(s) contain polygonal borders possibly with rounded corners; where said pattern(s) contain encoded digital information representing said credentials; where said acceptance criteria are applied to the digital data encoded in said pattern(s) to determine the acceptance or rejection of said credentials; an output means of conveying said acceptance or rejection outcome; capture means for capturing video or still images; where said capture system is composed of multiple image sensors with differing optical characteristics; recognition means for recognizing said pattern(s) in video or still images captured from said image sensors; where said recognition means for detecting said pattern(s) comprises the steps of: using an edge detector to detect an edge in said images or video frames;
grouping more than one edge into one or more polygons;
calculating a homography mathematical representation for said polygons;
generating a list of homographies;
extracting digital data from said video or still images using said homographies;
verifying if the polygon matches a valid fiducial marker pattern by performing checksum and error correction functions in all possible rotation positions; and if said verification is successful applying the digital data to said acceptance criteria.

2. The system of claim 1 where the optical characteristics of said image sensors are chosen such that each sensor's range of irradiance (incoming light intensity) sensitivity is chosen to operate in a different range within the full expected irradiance range expected for a given scene and application.

3. The system of claim 2 where said ranges of each sensor overlap in said full expected range by the irradiance difference expected between the light and dark regions of said patterns, such that the irradiance from both said light and dark regions of any said pattern will lie within the said range of at least one of said image sensors.

4. The system of claim 1 where the criteria being verified are either an entity's identity and/or if the entity contains some desired attributes.

5. The system of claim 1 where the entity being verified is a human being, a vehicle, an automated machine or a package.

6. The system of claim 1 where said output means controls an electromechanical lock to enter a door or cabinet, or to enable some machine's function.

7. The system of claim 1 where said output means controls lights and/or triggers audio signals to signal the acceptance or rejection of the entity.

8. The system of claim 1 where said output means displays acceptance and rejection information on a display screen.

9. The system of claim 8 where said acceptance or rejection information is shown overlaid over the video or still images obtained from one or more of the image sensors aligned with the image of the entity is said video or still images.

10. The system of claim 8 where output means also provides additional information determined from the entity's fiducial marker pattern(s).

11. The system of claim 10 where said information is shown overlaid over the video or still images obtained from one or more of the image sensors aligned with the image of the entity is said video or still images.

12. The system of claim 1 where this/these fiducial marker pattern(s) is/are printed on or engraved onto a surface attached to or held by the entity.

13. The system of claim 1 where said pattern(s) are shown on the screen of a mobile electronic device attached to or held by the entity instead of fixed printed pattern(s).

14. The system of claim 11 where said pattern(s) on said screen change with time in a synchronized sequence known to the capture device to provide an additional level of security.

15. The system of claim 1 where different image sensors in the capture means contain light sensitive components such as different sized electronic imager integrated circuits to provide a variety of light sensitivity, size and cost.

16. The system of claim 1 where each of the image sensors in the capture means contains a different lens apparatus, iris diaphragm, light filter including illumination, wavelength and polarization properties from the other image sensors such that each individual image sensor can capture video or still images of a given scene with differing light qualities.

17. The system of claim 14 where light filters are chosen considering the dynamic range of intensity that the light sensitive integrated circuits in each image sensor possesses in order to maximize the range of scene illumination where at least one image sensor will have said expected light and dark parts of said patterns both within the dynamic range of said integrated circuits.

18. The system of claim 1 where each of the image sensors in the capture means contains different filters or image sensor technology such that each image sensor can capture video or still images from different wavelengths or polarization of light.

19. The system of claim 1 where said criteria being verified are entrance tickets to an event.

20. The system of claim 19 where said pattern(s) are shown on the screen of a mobile electronic device attached to or held by the entity instead of fixed printed pattern(s).

21. The system of claim 9 where said entities are customers entering a venue at a checkpoint; where said criteria being verified are entrance tickets to said venue; and where said display screen is visible to customers and/or security staff.

22. The system of claim 1 where said credentials are customer identification for use in accelerating customers' orders or handling customer reward points.

23. The system of claim 22 where said pattern(s) is/are in printed form placed on or behind the windshield of a car going through a drive-through business.

24. The system of claim 1 where the said image sensors are mounted on a disposal point for recycling waste items where said credentials are whether a waste item has been considered returned yet.

25. The system of claim 1 where said image sensors are mounted in a weather station all aimed at fixed patterns mounted at fixed distances from said weather station so as to measure the visibility distance.
